(19) United States
(12) Patent Application Publication
(10) Pub. No.: US 2005/0114264 A1
(43) Pub. Date: May 26, 2005

(54) System and method for remoteley generating instruments

(75) Inventors: John W. Torget, Chadds Ford, PA (US); Kevin P. Watters, Wilmington, DE (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: First USA Bank NA

(21) Appl. No.: 11/034,175

(22) Filed: Jan. 12, 2005

Related U.S. Application Data
(62) Division of application No. 09/800,997, filed on Mar. 8, 2001.
(60) Provisional application No. 60/250,127, filed on Dec. 1, 2000.

(51) Int. Cl. G06F 17/60

(52) U.S. Cl. 705/44

(57) ABSTRACT

Systems and methods are provided for remotely generating an instrument. A request for the instrument is received from a customer, the instrument is generated in electronic form and a first security image in electronic form is added to the electronic form of the instrument to create a composite image. The composite image in electronic form is transmitted to the customer for printing by the customer.

This application claims the benefit of U.S. Provisional Application No. 60/250,127, filed Dec. 1, 2000.

### FIELD OF THE INVENTION

Certain embodiments of the present invention are generally related to systems and methods of generating instruments, and more particularly to systems and methods for remotely generating financial or other instruments.

### BACKGROUND OF THE INVENTION

People requiring certified funds are, for the most part, currently faced with having to physically travel to a branch of a bank in which they hold a demand deposit account. They are then generally required to fill in a withdrawal slip and present it to the bank teller, who prepares, for example, a certified check or a travelers' check. This requirement to be physically present at the issuing bank can be a significant problem when the certified funds are needed outside of normal banking hours or when the customer lives many miles from the nearest bank branch. Moreover, travelers' checks may only be issued in predetermined denominations, such as $100 amounts. Other problems exist.

### SUMMARY OF THE INVENTION

The invention solves at least these problems and others in the art by providing systems and methods for remotely generating instruments such as, for example, certified checks, travelers checks and other original documents or instruments.

Certain embodiments of the invention solve at least these problems by providing systems and methods that allow a customer to contact his or her bank via telephone or computer, request, for example, a certified check, and have the certified check print out on a printer at the customer's home or office. Particular embodiments provide for certain security measures to be included in the systems and methods to help prevent unauthorized use of the instrument, once generated.

Although the example of a customer using systems and methods of the invention to print and use certified checks for the purpose of purchasing an automobile is used in the following description, it is noted that many other types of instruments can be generated using the invention. For example, travelers checks can be printed at the home of a user prior to departing on a trip. The travelers checks can be printed in various convenient denominations and quantities. Other documents such as, for example, passports, birth certificates, loan documents, stock certificates, professional Certificates of Good Standing, and other documents requiring some evidence of authenticity can be generated using systems and methods of the invention.

### BRIEF DESCRIPTION OF THE DRAWING FIGURES

The invention will be more fully understood from the following Detailed Description of Preferred Embodiments and the following figures, of which:

FIG. 1 is a flow chart showing a first embodiment of the invention;

FIG. 2 is a flow chart showing a portion of a second embodiment of the invention;

FIG. 3 is a flow chart showing a portion of a third embodiment of the invention;

FIG. 4 is a flow chart showing a portion of a fourth embodiment of the invention;

FIG. 5 is a flow chart showing a portion of a fifth embodiment of the invention;

FIG. 6 is a flow chart showing a portion of a sixth embodiment of the invention;

FIG. 7 is a flow chart showing a portion of a seventh embodiment of the invention;

FIG. 8 is a schematic diagram of an embodiment of the invention using a computer; and

FIG. 9 is a schematic diagram of an embodiment of the invention using a telephone.

### DETAILED DESCRIPTION OF PREFERRED EMBODIMENTS

With the ever present concern regarding authenticity of documents and the growing demand for convenience in today's world, systems and methods according to the invention for allowing a customer of, for example, a financial institution to print instruments having verifiable authenticity in the customer's home or office may offer valuable advantages. The following embodiments of such systems and methods will be described with reference to printing a certified check at the home of a customer of a bank. It is noted, however, that many other types of instruments such as, for example, travelers checks, credit card convenience checks, loan documentation, birth certificates and other such important documents can also be printed remotely from the issuing institution using the systems and methods of the invention. Similarly, issuing institutions other than banks can also use the systems and methods of the invention.

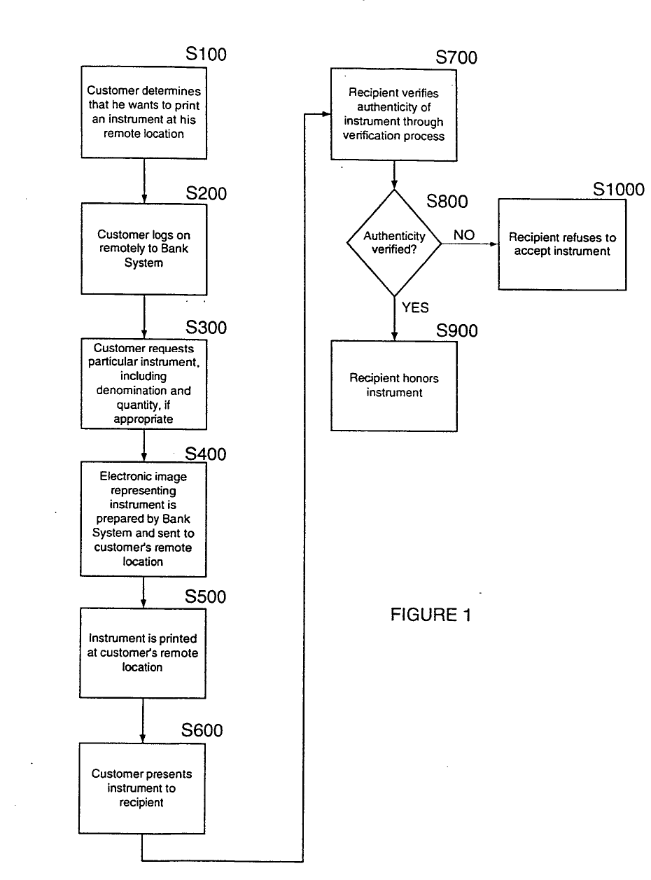

FIG. 1 shows a flow chart of an example of a first embodiment of the invention. In FIG. 1, at S100 a customer determines that he wants to print an instrument at his remote location. The remote location could be, for example, the customer's home, place of business, vehicle or other remote location. One example is a customer determining that he wants to print a certified check at his home to be used for the purchase of a new automobile.

In S200, the customer logs onto the bank system using, for example, his personal computer located at his home. The customer can log onto the bank system in a variety of ways including through the bank's web site using a specific password or other security measures. Once the customer successfully logs onto the bank system, processing proceeds to S300.

In S300, the customer requests a particular instrument, including denomination and quantity, if appropriate. In this example, where the customer is requesting a certified check, his request may include the denomination, or amount, of the check as well as the entity to which the check is to be made payable. If, for example, the customer was unsure of the exact amount to be paid for his new automobile, he could request two or more certified checks to facilitate his negotiations with the automobile dealer. For example, he could request one certified check in the amount of $20,000 and two certified checks in the amount of $2,000 each. In this way, he can have in his possession certified funds totaling $24,000 for use, as needed, without having the entire amount in one check. The request by the customer will also include the source of the funds for purchase of the certified check. This source could be the customer's deposit account, in which case the certified check could be made out to the customer himself. The source could also be a loan, in which case the certified check could be made out to the recipient (in this example, the automobile dealer) or jointly to the customer and the recipient. In other embodiments, the user may choose a selectable currency, such as Euros or others, for travel or other purposes. Once the customer's request is complete and is approved by the bank, processing proceeds to S400.

In S400 an electronic image representing the instrument is prepared by the bank system and sent to the customer's remote location. In this example, an electronic image of the certified check, or checks, is sent to the customer's personal computer at his home. The image may be transmitted, for example, as a computer readable file in JPG, GIF, BMP, TIFF or other formats. In other embodiments, the bank system and customer's personal computer and printer are coordinated such that the electronic image of the instrument is in a format compatible with the customer's equipment. Processing then proceeds to S500.

In S500, the instrument is printed at the customer's remote location. In this example, the customer's personal computer prepares the electronic image for printing on the customer's printer and sends the image to the printer. The instrument, in this example the certified check, or checks, is printed on the customer's printer. Processing then proceeds to S600. Printing may be via laser printer, color laser printer, inkjet, bubble jet, dye sublimation or other printing hardware or media.

In S600, the customer may take the generated instrument and presents it to the recipient. In this example, the customer takes the certified checks to the automobile dealer and presents them to the dealer in exchange for a new automobile. Processing then proceeds to S700.

In S700, the recipient may verify the authenticity of the instrument through a verification process. Some examples of the verification process of S700 are described below. Processing then proceeds to S800.

In S800, it is determined whether the authenticity of the instrument may be verified. If, in S800, the authenticity of the instrument is verified, the recipient honors the instrument. In this example, the automobile dealer accepts the certified checks as if they were cash. If, on the other hand, the authenticity of the instrument is not verified in S800, processing proceeds to S1000 where the recipient refuses to accept the instrument. In this example, the automobile dealer does not accept the certified checks because the dealer has not been able to verify their authenticity.

FIG. 1 and the above describe an overview of only one example of systems and methods of the invention.

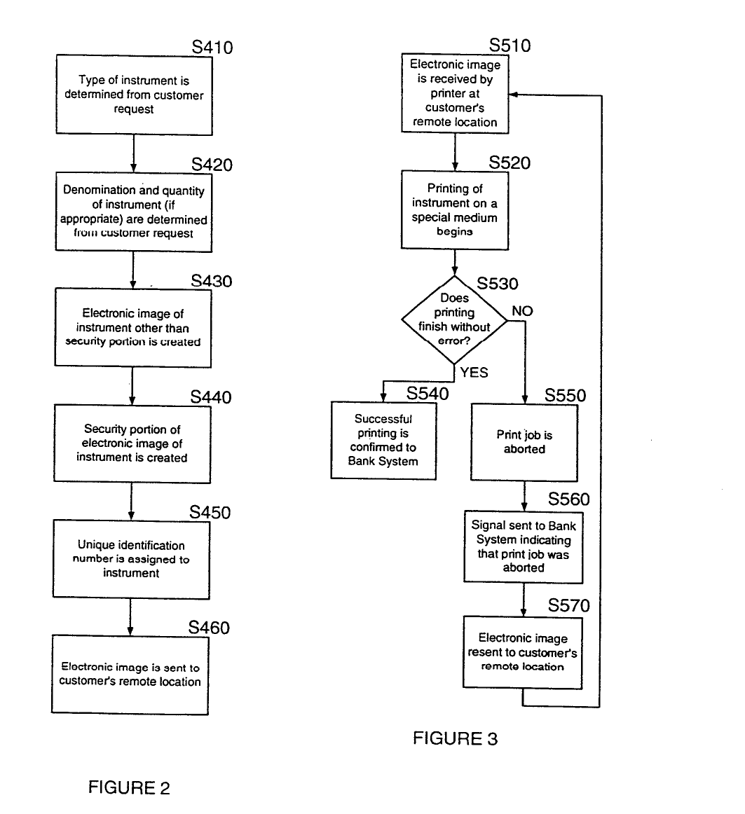

FIG. 2 describes one example of the process represented by S400 in FIG. 1. In S410 of FIG. 2, the bank system determines the type of instrument required from the customer request. In this example, the bank system determines that the customer requests a certified check or checks. Processing then proceeds to S420.

In S420, the bank system determines the denomination and quantity of the instrument required from the customer request. In this example, the bank system would determine that three certified checks having values of $20,000, $2,000 and $2,000 are required. Processing then proceeds to S430.

In S430, the bank system creates an electronic image of the instrument, absent any security portion. In this example, the bank system creates electronic images of the three certified checks. Processing then proceeds to S440.

In S440, a security portion of the electronic image of each instrument is created. One example of such a security portion is a watermark that is printed along with the instrument embedded within the digital image. The watermark may be readable on the original instrument that is printed, but is not readable on any photocopy of the instrument. An example of such a watermark is one that is embedded directly in the electronic image by modulating the brightness of specific image pixels. This modulation can be unique to that specific image. Using such a security measure may prevent usable photocopies of the instrument from being made. Processing then proceeds to S450.

In S450, a unique identification number may be assigned to each instrument. In this example, each certified check would be assigned a unique identification or serial number. Also, depending on the type of instrument, the unique identification or serial number can become part of the electronic image of the instrument. In addition, a barcode or other computer readable representation of the unique identification or serial number can be included in the electronic image. This computer readable representation of the unique identification number can be scanned as a part of determining the validity of the instrument discussed below). Processing then proceeds to S460.

As an optional security feature, identification of the customer's remote location can be verified. An example of this verification is the customer's personal computer containing a preassigned identification number embedded in its memory. The bank system then verifies that the identification number embedded in the memory of the customer's computer matches the identification number previously assigned to that customer and recorded in the bank system. This optional feature preferably includes a mechanism to allow customers to update their location and add new locations by, for example, properly responding to a security question. Owner verification techniques, such as smart card or other readers, retinal, fingerprint or other biometric scans, or other security methods may be used. With the use of a security feature or check, once identification of the customer's remote location is verified, processing proceeds to S460.

In S460, an electronic image of the instrument is sent to the customer's remote location. The electronic image includes, in this example, images of the three certified checks including the watermarks and the unique identification numbers assigned to the instruments. A mechanism for allowing customers to update, add and delete remote locations can be provided. Such a mechanism would preferably include a security measure, such as the customer answering a security question, that must be satisfied prior to any updating, adding or deleting. After S460, processing continues with S500 as shown in FIG. 1.

FIG. 3 shows an example of processing associated with S500 of FIG. 1. In S510 of FIG. 3, the electronic image is received by a printer at the customer's remote location. In a preferred embodiment, the image is received by a personal computer at the customer's home and is then routed to the customer's printer for printing. Other examples of remote locations at which the instrument can be ordered and/or printed include, but are not limited to, small retail bank branches, bank kiosks, copy centers, hotel business centers, overseas travel centers, and third party retail stores such as, for example, shipping and packaging stores. Processing then proceeds to S520.

In S520, printing of the instrument begins on a medium. In this example, the medium may be a paper provided by the bank that contains a security device that helps prevent copying of the instrument. One example of a security device is a paper that may be either light or heat sensitive, such that when the paper is photocopied an image appears on the copy that is not visible on the original. For example, the word “void” could appear on photocopies of the paper due to thermal imprint but not on the paper itself. While the word “void” is used here as an example, it is noted that other words or phrases can be used. It is also noted that other technologies or methods of providing such a security feature on the instrument itself can be used. After printing of the instrument begins, processing proceeds to S530.

In S530, it may be determined whether the instrument was printed in its entirety without error. If it is determined in S530 that the printing was completed without error, processing proceeds to S540, where successful printing is confirmed to the bank system. If, however, printing is not completed without error is S530, processing proceeds to S550, where the print job of the particular instrument is aborted. Processing then proceeds to S560.

In S560, a signal may be sent to the bank system indicating that the print job was aborted. In the case of multiple instruments being printed, each instrument would be treated as a separate print job so that the signal indicating that a print job was aborted would be instrument specific. Processing then proceeds to S570.

In S570, after the bank system has received the signal indicating that the print job of a particular instrument has been aborted, the electronic image of that instrument may be resent to the customer's remote location so that printing of the instrument can be attempted again. Processing then proceeds to S510 and the above procedure may be repeated until the instrument is successfully printed.

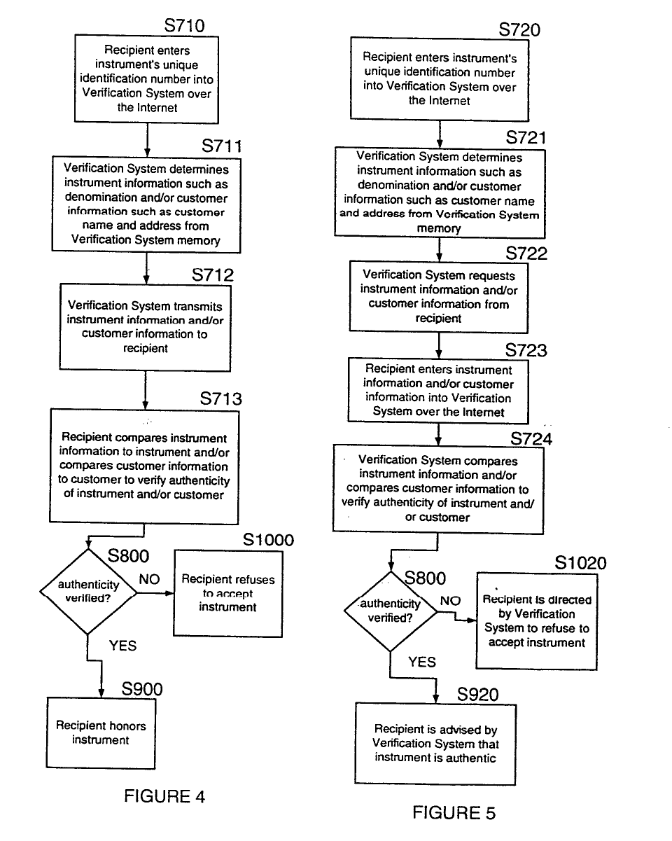

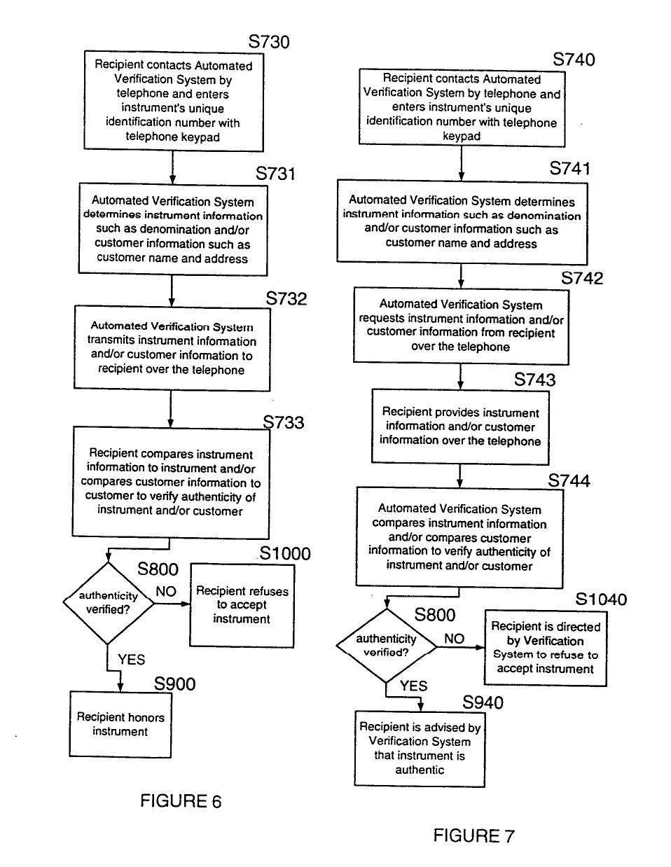

FIGS. 4-7 illustrate four examples of the process represented by S700 in FIG. 1. FIGS. 4 and 5 illustrate examples of computer based verification systems accessible over the Internet. FIGS. 6 and 7 illustrate examples of automated verification systems accessible over the telephone.

FIGS. 4 and 6 illustrate examples of verification systems that transmit instrument information and/or customer information to the recipient of the instrument. FIGS. 5 and 7 illustrate examples of verification systems in which the verification system requests instrument information and/or customer information from the recipient. An advantage of the verification systems of FIGS. 5 and 7 is that instrument information and/or customer information is not supplied to the recipient, but instead, recipient supplied instrument information and/or customer information is verified by the verification system. As a result, instrument information and/or customer information being accessed by other than legitimate recipients is avoided.

An advantage of the verification systems of FIGS. 4 and 6 is that these systems are generally quicker and easier to use than systems that require instrument information and/or consumer information to be entered by the recipient of the instrument. In system such as those shown in FIGS. 4 and 6, the information provided by the bank is preferably limited to, for example, instrument number, amount and the name of the entity to which the check is made payable.

While FIGS. 4 and 5 show examples of verification systems accessible over the Internet, it is noted that similar systems can be accessible over an intranet or other communication systems.

The customer information referred to in these examples could be any combination of customer name, address, telephone number, social security number, smart card based, biometric or other identifying information. The customer information could also be the name of the entity to which a certified check is made payable, which may or may not be the customer himself.

In S710 of FIG. 4, the recipient of the instrument may enter the instrument's unique identification number into the verification system over the Internet. In this example, an automobile dealer who has received the instrument (certified check) as payment for a new automobile logs onto the issuing bank's website over the Internet and gains access to a portion of the bank's system set up for verification of instruments. In some embodiments, access to that portion of the bank's system may be only granted after entering a password or other dealer identification. The recipient may then enter the instrument's unique identification number into the bank system. Processing then proceeds to S711.

In S711, the verification system determines instrument information such as denomination, instrument number and recipient name and/or customer information such as customer name and address from the memory of the verification system. Instrument information and customer information may be stored in the memory of the verification system when the customer obtains the instrument (in electronic form) from the bank system. This instrument information and customer information can be indexed by the instrument's unique identification number for quick retrieval upon receiving a request for verification from a recipient of the instrument. Processing then proceeds to S712.

In S712, the verification system may transmit the instrument information or the customer information to the recipient. In this example, the automobile dealer would see on his monitor or other interface that the instrument is a certified check in the amount of $20,000 made out to the dealer and the unique identification number of the check along with, possibly, the customer's name and address. This information can be used by the automobile dealer to confirm that the person presenting the certified check to him is indeed the authorized possessor of the check. As shown in S713, the recipient may compare the instrument information to the instrument and/or compare the customer information to the customer to verify authenticity of the instrument and or the customer. Processing then proceeds to S800.

S800, S900 and S1000 are similar to those shown in FIG. 1.

Another example of the process of S700 shown in FIG. 1 is illustrated in FIG. 5.

S720 and S721 are identical to S710 and S711, respectively, of FIG. 4.

In S722, unlike S712 of FIG. 12, the verification system requests instrument information and or customer information from the recipient of the instrument. In this example, the verification system may request that the automobile dealer enter, for example, the type of instrument and denomination and the customer's name and address. Processing then proceeds to S723.

In S723, the recipient may enter the information requested by the verification system in S722. In this example, the automobile dealer may enter the instrument type as a certified check and the instrument denomination as $20,000. The automobile dealer also enters the customer's name and address. Processing then proceeds to S724.

In S724, the verification system compares the instrument information or customer information entered by the recipient with the corresponding information stored in the memory of the verification system to verify authenticity of the instrument or the customer. In this example, the verification may compare the information entered by the automobile dealer with the information stored in the memory of the verification system that was stored when the customer received the electronic image of the certified check from the bank. Processing then proceeds to S800.

In S800, the authenticity of the instrument or the customer may be verified by the verification system. If the authenticity is verified in S800, processing proceeds to S920, where the recipient is advised by the verification system that the instrument is authentic. On the other hand, if the authenticity is not verified in S800, processing proceeds to S1020, where the recipient may be directed by the verification system to refuse to accept the instrument.

FIG. 6 shows another example of the process of S700 in FIG. 1. In S730 of FIG. 6, the recipient contacts an automated verification system by telephone and enters the instrument's unique identification number with the telephone key pad. In the example of the customer purchasing a car from an automobile dealer, the automobile dealer would dial into the automated verification system over his telephone and enter the instrument's unique identification number with a telephone key pad. Processing then proceeds to S731.

In S731, the automated verification system may determine the instrument information such as denomination and or customer information such as the customer's name and address that corresponds to the unique instrument identification number entered by the recipient in S730. Processing then proceeds to S732.

In S732, the automated verification system may transmit instrument information or customer information to the recipient over the telephone. In this example, the automobile dealer would hear over the telephone the type of instrument (certified check), the denomination of the instrument ($20,000) and the customer's name and address. Processing then proceeds to S733.

In S733, the recipient compares the instrument information to the instrument and/or compares the customer information to the customer to verify authenticity of the instrument and/or the customer. In this example, the automobile dealer would compare the instrument information and customer information heard over the telephone from the automated verification system to the instrument in his possession and the customer that presented the instrument to him. Processing then proceeds to S800.

In S800, the authenticity of the instrument and or customer is verified by the recipient. If the authenticity of the instrument and/or customer are verified in S800, processing proceeds to S900, where the recipient honors the instrument. If, however, authenticity is not verified in S800, processing proceeds to S1000, where the recipient refuses to accept the instrument.

FIG. 7 shows another example of the process of S700 in FIG. 1. S740 and S741 of FIG. 7 are similar to S730 and S731, respectively, of FIG. 6.

In S742, the automated verification system requests instrument information and/or customer information from the recipient of the instrument over the telephone. Processing then proceeds to S743.

In S743, the recipient provides the instrument information and/or customer information over the telephone to the automated verification system. In this example, the automobile dealer would state over the telephone that the instrument received is a certified check in the amount of $20,000 and may also state, for example, the customer's name, address, account number and/or social security number. Processing then proceeds to S744.

In S744, the automated verification system compares the instrument information or customer information received from the recipient with corresponding information stored in the memory of the automated verification system at the time of creation of the instrument. In an embodiment of the invention, this comparison is done through a VRU (voice recognition unit) in order to compare information stated by the recipient in spoken words to the information in the memory of the automated verification system.

If the information stated by the recipient matches or nearly matches the information in memory, the information in memory can be transmitted over the telephone in a computer generated voice for confirmation by the recipient. If, however, the information stated by the recipient does not match the information in memory, a human operator can intervene and complete the verification process. Additional safeguards can also be employed, such as, for example, requiring the customer to speak to the verification system over the telephone and using voice recognition software to compare the customer's voice to a stored speech pattern previously entered into the system by the customer. Such additional safeguards could be required in situations involving large sums of money or sensitive security issues. Processing then proceeds to S800.

In S800, if the authenticity of the instrument or customer are verified, the recipient may be advised in S940 by the verification system that the instrument is authentic. If, however, the authenticity of the instrument or customer are not verified in S800, processing proceeds to S1040, where the recipient may be directed by the verification system to refuse to accept the instrument.

Another embodiment of the invention allows customers to print credit card convenience checks at, for example, their home or office. Allowing remote printing of convenience checks by customers can save significant marketing dollars on direct mail costs, reduce fraud risk and exposure from US Postal delivery process, and provide greater customer flexibility in utilizing their available credit balance. Currently, direct mail is used to distribute millions of convenience checks annually to current credit card customers to promote additional transactions. A special, limited time, low-rate offer often applies to the convenience checks, with an expiration date placed on the actual checks. The convenience checks usually come in a batch of three or four with a cover letter that highlights benefits.

While customers can currently request convenience checks at anytime by calling the issuing bank's customer service department, it often takes 7 to 10 business days for delivery. Printing convenience checks at a customer-designated location can be almost immediate and can utilize security mechanisms such as those described above to prevent duplication.

An example of a system for printing convenience checks includes a customer logging in to their credit card account online and typing in the number of checks wanted, the system generating the correct routing, account and check numbers for the checks, and the individual checks being printed out at the customer-designated location.

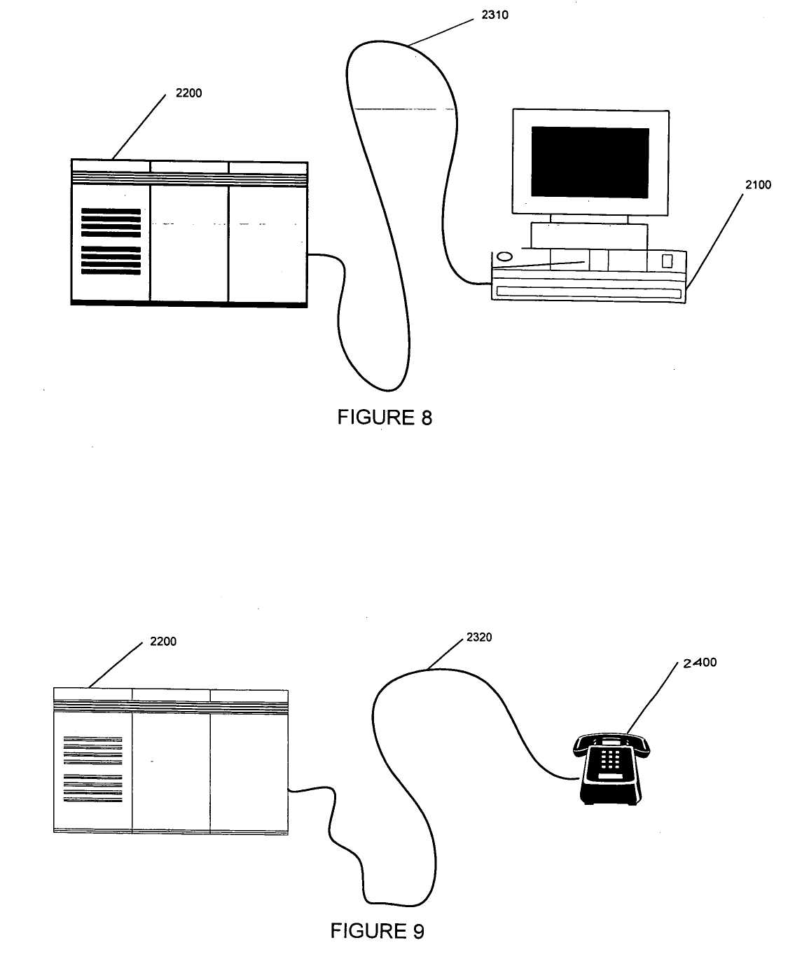

FIG. 8 shows an example of a system of the invention having a computer or terminal 2100 connected to a computer 2200 by a data connection 2310. The computer 2100 could be a computer in a customer's home or a computer in a recipient's place of business. The computer 2200 could be a computer on which the bank system resides. The data connection 2310 can be a phone line, other wired communication link or a wireless link, for example.

FIG. 9 shows a system of the invention by which verification is performed over a telephone line. FIG. 9 shows a telephone 2400 connected to a computer 2200 by a telephone connection 2320. The telephone connection 2320 can be a wired connection or a wireless connection. The verification can be performed, for example, through the use of a wireless phone or personal digital assistant (PDA).

While the foregoing description includes many details and specificities, it is to be understood that these have been included for purposes of explanation only, and are not to be interpreted as limitations of the present invention. Modifications to the embodiments described above can be made without departing from the spirit and scope of the invention, as is intended to be encompassed by the following claims and their legal equivalents.

1-28. (canceled)

29. A method of distributing and verifying the authenticity of an instrument, comprising:
a) receiving customer information and a request for the instrument from a customer;
b) generating the instrument in electronic form;
c) adding a first security image in electronic form to the electronic form of the instrument to create a composite image;
d) transmitting the composite image in electronic form to the customer for printing by the customer as the instrument;
e) receiving a request for verification from a recipient of the printed instrument, the recipient receiving the printed instrument from the customer;
f) verifying whether the instrument is authentic based on the customer information; and
g) communicating to the recipient whether the instrument is authentic.

30. The method of claim 29, wherein the first security image comprises a watermark that appears as a part of the composite image when printed.

31. The method of claim 30, wherein the first security image is invisible on a photocopy of the instrument.

32. The method of claim 31, wherein the composite image is for printing on a medium having a second security image.

33. The method of claim 32, wherein the second security image is invisible on the instrument and is visible on a photocopy of the instrument.

34. The method of claim 33, wherein the second security image comprises the word “void.”

35. The method of claim 29, wherein the composite image is for printing on a medium having a second security image.

36. The method of claim 35, wherein the second security image is invisible on the instrument and is visible on a photocopy of the instrument.

37. The method of claim 36, wherein the second security image comprises the word “void.”

38. The method of claim 29, wherein the instrument comprises a monetary instrument.

39. The method of claim 38, wherein the instrument represents certified funds.

40. The method of claim 39, wherein the instrument is generated by an issuing financial institution, the finds are certified by the issuing financial institution and the customer holds a deposit account with the issuing financial institution.

41. The method of claim 40, wherein the funds are withdrawn from the customer's deposit account.

42. The method of claim 38, wherein the request comprises at least one of an amount, a denomination and a currency of the monetary instrument.

43. The method of claim 29, wherein the instrument comprises at least one of a stock certificate and a bond.

44. The method of claim 29, wherein the instrument has associated with it a unique identification number.

45. The method of claim 29, wherein the request for verification and the communication are transmitted over a data link.

46. The method of claim 45, wherein the data link is the Internet.

47. The method of claim 29, wherein the request for verification and the communication are transmitted over a telephone line.

48. The method of claim 29, wherein the verification comprises:
h) receiving from the recipient submitted customer information; and
i) comparing the submitted customer information to the customer information received from the customer.

49. The method of claim 48, wherein the submitted customer information comprises a customer name and a customer address.

50. The method of claim 49, wherein the verification further comprises:
j) receiving from the recipient a submitted instrument identification number; and
k) comparing the submitted instrument identification number to an assigned instrument identification number assigned to the instrument before the composite image is transmitted to the customer.

51. A method of distributing and verifying the authenticity of an instrument representing certified funds, comprising:
a) receiving customer information and a request for the instrument from a customer;
b) generating the instrument in electronic form;
c) adding a first security image in electronic form to the electronic form of the instrument to create a composite image;
d) transmitting the composite image in electronic form to the customer for printing by the customer as the instrument;
e) receiving a request for verification from a recipient of the printed instrument, the recipient receiving the printed instrument from the customer;
f) verifying whether the instrument is authentic based on the customer information; and
g) communicating to the recipient whether the instrument is authentic;
wherein the first security image comprises a watermark that appears as a part of the composite image when printed and is invisible on a photocopy of the instrument,
the composite image is for printing on a medium having a second security image, the second security image being invisible on the instrument and visible on a photocopy of the instrument, and
the instrument is generated by an issuing financial institution, the funds are certified by the issuing financial institution and the customer holds a deposit account with the issuing financial institution.

52. A system that distributes and verifies the authenticity of an instrument, comprising;
a first processor that receives customer information and a request for the instrument from a customer, generates the instrument in electronic form, and adds a first security image in electronic form to the electronic form of the instrument to create a composite image;
a first communications module that transmits the composite image in electronic form to the customer for printing by the customer as the instrument;
a second processor that
receives a request for verification from a recipient of the printed instrument, the recipient receiving the printed instrument from the customer, and
verifies whether the instrument is authentic based on the customer information; and
a second communications module that transmits a communication to the recipient, the communication indicating whether the authenticity of the instrument is verified.

53. The system of claim 52, wherein the first security image comprises a watermark that appears as a part of the composite image when printed.

54. The system of claim 53, wherein the first security image is invisible on a photocopy of the instrument.

55. The system of claim 54, wherein the composite image is for printing on a medium having a second security image.

56. The system of claim 55, wherein the second security image is invisible on the instrument and is visible on a photocopy of the instrument.

57. The system of claim 52, wherein the composite image is for printing on a medium having a second security image.

58. The system of claim 57, wherein the second security image is invisible on the instrument and is visible on a photocopy of the instrument.

59. The system of claim 52, wherein the instrument comprises a monetary instrument that represents certified funds.

60. The system of claim 59, wherein the instrument is generated by an issuing financial institution, the funds are certified by the issuing financial institution and the customer holds a deposit account with the issuing financial institution.

61. The system of claim 52, wherein the instrument has associated with it a unique identification number.

62. The system of claim 52, wherein the verification comprises:
receiving from the recipient submitted customer information; and
comparing the submitted customer information to the customer information received from the customer.

63. The system of claim 63, wherein the submitted customer information comprises a customer name and a customer address.

64. The system of claim 63, wherein the verification further comprises:
receiving from the recipient a submitted instrument identification number; and
comparing the submitted instrument identification number to an assigned instrument identification number assigned to the instrument before the composite image is transmitted to the customer.

65. A system that distributes and verifies the authenticity of an instrument representing certified funds, comprising;
a first processor that receives customer information and a request for the instrument from a customer, generates the instrument in electronic form, and adds a first security image in electronic form to the electronic form of the instrument to create a composite image;
a first communications module that transmits the composite image in electronic form to the customer for printing by the customer as the instrument;
a second processor that
receives a request for verification from a recipient of the printed instrument, the recipient receiving the printed instrument from the customer, and
verifies whether the instrument is authentic based on the customer information; and
a second communications module that transmits a communication to the recipient, the communication indicating whether the authenticity of the instrument is verified,
wherein the first security image comprises a watermark that appears as a part of the composite image when printed and is invisible on a photocopy of the instrument,
the composite image is for printing on a medium having a second security image, the second security image being invisible on the instrument and visible on a photocopy of the instrument, and
the instrument is generated by an issuing financial institution, the funds are certified by the issuing financial institution and the customer holds a deposit account with the issuing financial institution.

66. (canceled)

67. An electronically readable recording medium containing a program that when run by a processor performs the steps of:
a) receiving customer information and a request for a remotely generated instrument from a customer;
b) generating the instrument in electronic form;
c) adding a first security image in electronic form to the electronic form of the instrument to create a composite image;
d) transmitting the composite image in electronic form to the customer for printing by the customer as the instrument;
e) receiving a request for verification from a recipient of the printed instrument, the recipient receiving the printed instrument from the customer;
f) verifying whether the instrument is authentic based on the customer information; and
g) communicating to the recipient whether the instrument is authentic.

68. (canceled)
